(19) United States
(12) Patent Application Publication
(10) Pub. No.: US 2013/0275655 A1
(43) Pub. Date: Oct. 17, 2013

(54) MEMORY MANAGEMENT METHOD AND MEMORY CONTROLLER AND MEMORY STORAGE DEVICE USING THE SAME

(71) Applicant: Ching-Wen Chang, Hsinchu City (TW)

(72) Inventor: Ching-Wen Chang, Hsinchu City (TW)

(73) Assignee: PHISON ELECTRONICS CORP., Miaoli (TW)

(21) Appl. No.: 13/549,523

(22) Filed: Jul. 16, 2012

(30) Foreign Application Priority Data
Apr. 17, 2012 (TW) 101113618

(51) Int. Cl. G06F 12/00

(52) U.S. Cl. 711/103; 711/E12.008

(57) ABSTRACT

A memory management method for a rewritable non-volatile memory module including physical unit unions is provided. The physical unit unions are at least partitioned into a data area and a second area. Logical unit union addresses are managed by a file system and would be allocated and mapped to the physical unit unions of the data area. The method includes executing a procedure if a programming error occurs when programming a third physical unit union of the second area. The procedure includes obtaining a second physical unit union mapped to a second logical unit union address from the data area and mapping the second logical unit union address to the third physical unit union. Accordingly, the lifespan of the rewritable non-volatile memory module would be prolonged by the method.

### CROSS-REFERENCE TO RELATED APPLICATION

This application claims the priority benefit of Taiwan application serial no. 101113618, filed on Apr. 17, 2012. The entirety of the above-mentioned patent application is hereby incorporated by reference herein and made a part of this specification.

### BACKGROUND

1. Technical Field

The present invention relates to a memory management method and, more particularly to a memory management method, a memory controller and memory storage device using the same for a rewritable non-volatile memory module.

2. Related Art

Along with the rapid development of digital cameras, cell phones, and MP3 in recently years, the consumers' demand to storage media has increased drastically. Since a rewritable non-volatile memory nodule (for example, a flash memory) has characteristics such as data non-volatility, low power consumption, small volume, and non-mechanical structure, etc., it becomes suitable for various aforementioned portable multimedia devices.

Typically, the rewritable non-volatile memory module includes a plurality of physical blocks, and a portion of the physical blocks are provided to a host system for being accessed thereby. When a physical block provided to the host system is damaged, one physical block in a replacement area is gotten for replacing the damaged physical block. When no usable physical block exists in the replacement area, it indicates that the lifespan of the rewritable non-volatile memory module is ended. However, at this time, there may be some spare physical blocks available in the rewritable non-volatile memory module. Ending the lifespan of the rewritable non-volatile memory module would lead to the waste of the memory spaces. Accordingly, how to prolong the lifespan of the rewritable non-volatile memory module when no usable physical block exists in the replacement area is an important concern to persons in this field.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention is directed to a memory management method, a memory storage device and a memory controller, by which the lifespan of a rewritable non-volatile memory can be prolonged.

According to an exemplary embodiment of the present invention, a memory management method is provided for a rewritable non-volatile memory module. The rewritable non-volatile memory module includes a plurality of physical unit unions, and the plurality of physical unit unions is at least partitioned into a data area and a second area. A plurality of logical unit union addresses is configured and mapped to the plurality of physical unit unions in the data area, and the plurality of logical unit union addresses is managed by a file system. The memory management method includes receiving a write command, in which the write command instructs to write data to a first logical unit union address among the plurality of the logical unit union addresses, and the first logical unit union address is mapped to a first physical unit union in the data area. The memory management method also includes programming the data to a third physical unit union in the second area, determining whether a programming error occurs when programming the data to the third physical unit union, and executing a first procedure if the programming error occurs. The first procedure includes obtaining a second physical unit union from the data area, wherein the second physical unit union is mapped to a second logical unit union address among the plurality of logical unit union addresses, and mapping the second logical unit union address to the third physical unit union.

According to another exemplary embodiment of the present invention, a memory storage device including a connector, a rewritable non-volatile memory module and a memory controller is provided. The connector is configured to be coupled to a host system. The rewritable non-volatile memory module includes a plurality of physical unit unions, and the plurality of physical unit unions is at least partitioned into a data area and a second area. A plurality of logical unit union addresses is configured and mapped to the plurality of physical unit unions in the data area, and the plurality of logical unit union addresses is managed by a file system. The memory controller is coupled to the connector and the rewritable non-volatile memory module. The memory controller is configured to receive a write command from the host system. The write command instructs to write data to a first logical unit union address among the plurality of the logical unit union addresses. The first logical unit union address is mapped to a first physical unit union in the data area. The memory controller is also configured to program the data to a third physical unit union in the second area and determine whether a programming error occurs when programming the data to the third physical unit union. If the programming error occurs, the memory controller is configured to obtain a second physical unit union from the data area, and the second physical unit union is mapped to a second logical unit union address among the plurality of logical unit union addresses. The memory controller is configured to map the second logical unit union address to the third physical unit union.

According to still another exemplary embodiment of the present invention, a memory controller including a host interface, a memory interface and a memory management circuit is provided. The host interface is configured to be coupled to a host system. The memory interface is configured to be coupled to a rewritable non-volatile memory module having a plurality of physical unit unions, and the plurality of physical unit unions is at least partitioned into a data area and a second area. The plurality of logical unit union addresses is configured and mapped to the plurality of physical unit unions in the data area. The memory management circuit is coupled to the host interface and the rewritable non-volatile memory module. The memory management circuit is configured to receive a write command from the host system. The write command instructs to write data to a first logical unit union address among the plurality of the logical unit union addresses. The first logical unit union address is mapped to a first physical unit union in the data area. The memory management circuit is configured to program the data to a third physical unit union in the second area and determine whether a programming error occurs when programming the data to the third physical unit union. If the programming error occurs, the memory management circuit is configured to obtain a second physical unit union from the data area, and the second physical unit union is mapped to a second logical unit union address among the plurality of logical unit union addresses. The memory management circuit is configured to map the second logical unit union address to the third physical unit union.

Based on the above, in the memory management method, the memory storage device and the memory controller as disclosed in the embodiments of the present invention, the physical unit unions in the data area can be configured to replace the physical unit unions where the programming error occurs and accordingly, the lifespan of the rewritable non-volatile memory module can be increased.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1A illustrates a host system and a memory storage device according to an exemplary embodiment of the present invention.

FIG. 1B is a schematic diagram illustrating a computer, an input/output (I/O) device and memory storage device according to an exemplary embodiment of the present invention.

FIG. 1C is a schematic diagram illustrating a host system and a memory storage device according to an exemplary embodiment of the present invention.

FIG. 2 is a schematic block diagram illustrating the memory storage device depicted in FIG. 1A.

FIG. 3 is a schematic block diagram illustrating a memory controller according to an exemplary embodiment of the present invention.

FIGS. 4 and 5 are schematic diagrams illustrating examples of managing a rewritable non-volatile memory module according to an exemplary embodiment of the present invention.

FIG. 6 is a schematic diagram illustrating an example of a file system according to an exemplary embodiment of the present invention.

FIG. 7 is a schematic diagram illustrating an example of a file allocation table area, a root directory area and a file area according to an exemplary embodiment of the present invention.

FIG. 8 is a schematic diagram illustrating an example of creating an invalid file according to an exemplary embodiment of the present invention.

FIG. 9 is a schematic diagram illustrating an example of recording a file description block corresponding to an invalid file in a directory entry field according to an exemplary embodiment of the present invention.

FIG. 10 is a schematic diagram illustrating an example of creating an invalid file according to another exemplary embodiment of the present invention.

FIG. 11 is a flowchart illustrating a memory management method according to an exemplary embodiment of the present invention.

### DESCRIPTION OF EMBODIMENTS

Reference will now be made in detail to the present preferred embodiments of the present invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, a memory storage device (i.e. a memory storage system) includes a rewritable non-volatile memory module and a controller (i.e. a control circuit). The memory storage device is used together with a host system so that the host system can write data into or read data from the memory storage device.

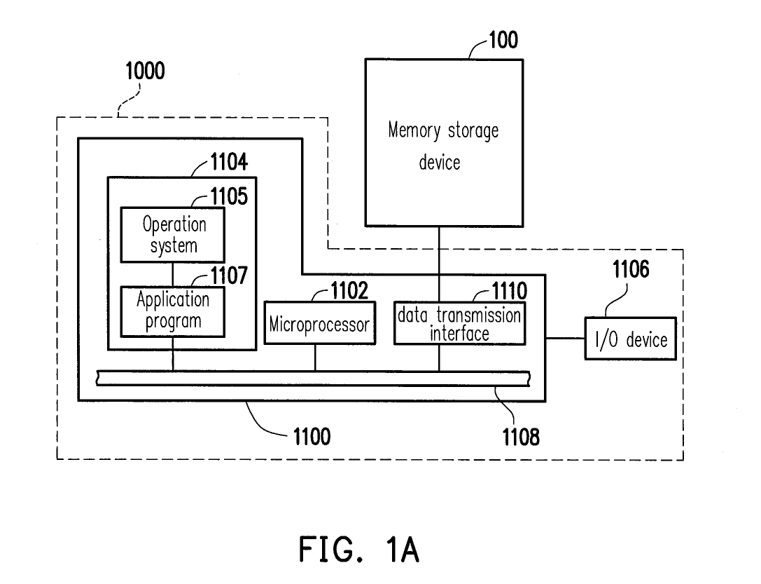

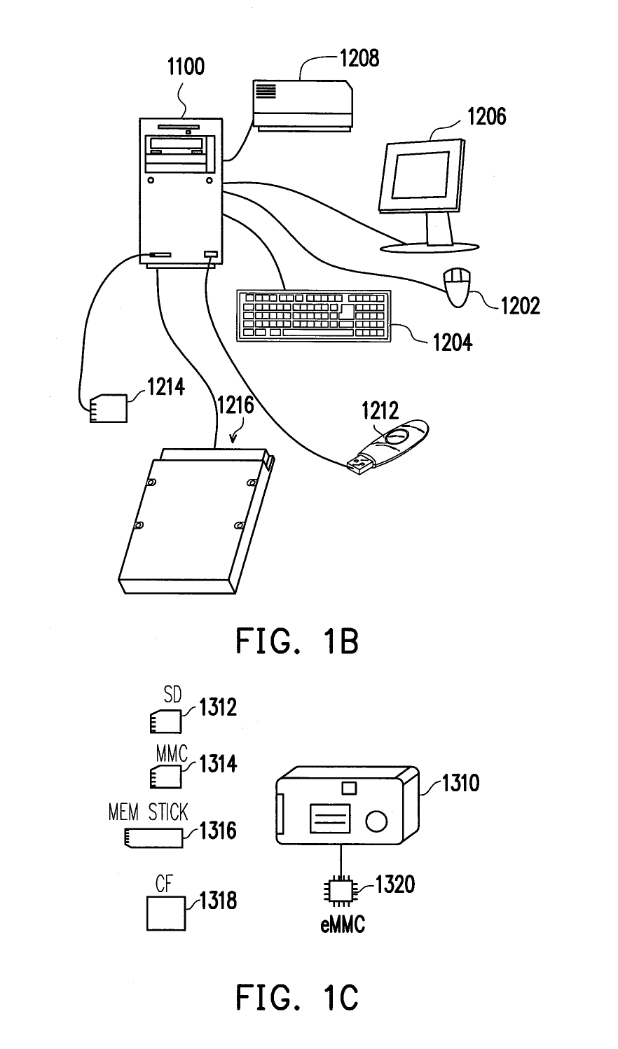

FIG. 1A illustrates a host system and a memory storage device according to an exemplary embodiment of the present invention.

With reference to FIG. 1A, a host system 1000 in most cases includes a computer 1100 and an input/output (I/O) device 1106. The computer 1100 includes a microprocessor 1102, a random access memory (RAM) 1104, a system bus 1108, and a data transmission interface 1110. The microprocessor 1102 executes an operation system 1105 and an application program 1107 loaded into the RAM 1104 so that the host system 1000 provides a corresponding function according to a user operation. The I/O device 1106 includes a mouse 1202, a keyboard 1204, a display 1206, and a printer 1208, as shown in FIG. 1B. It should be understood that, the devices depicted in FIG. 1B should not be construed as limitations to the present disclosure, and the I/O device 1106 may include other devices as well.

In an exemplary embodiment of the present invention, the memory storage device 100 is coupled to other devices of the host system 1000 through the data transmission interface 1110. By operating the microprocessor 1102, the RAM 1104, and the I/O device 1106, the data can be written into or read from the memory storage device 100. For instance, the memory storage device 100 may be a rewritable non-volatile memory storage device, such as a flash drive 1212, a memory card 1214, or a solid state drive (SSD) 1216, as shown in FIG. 1B.

Generally, the host system 1000 can substantially be any system used together with the memory storage device 100 for storing data. Even though the host system 1000 is described as a computer system in the present exemplary embodiment, the host system 1000 in another exemplary embodiment may be a digital camera, a video camera, a communication device, an audio player, a video player, and so on. For instance, if the host system is a digital camera (video camera) 1310, the rewritable non-volatile memory storage device is an SD card 1312, an MMC card 1314, a memory stick 1316, a CF card 1318 or an embedded storage apparatus 1320 (as shown in FIG. 1C). The embedded storage device 1320 includes an embedded MMC (eMMC). It should be noted that the eMMC is directly coupled to a substrate of the host system.

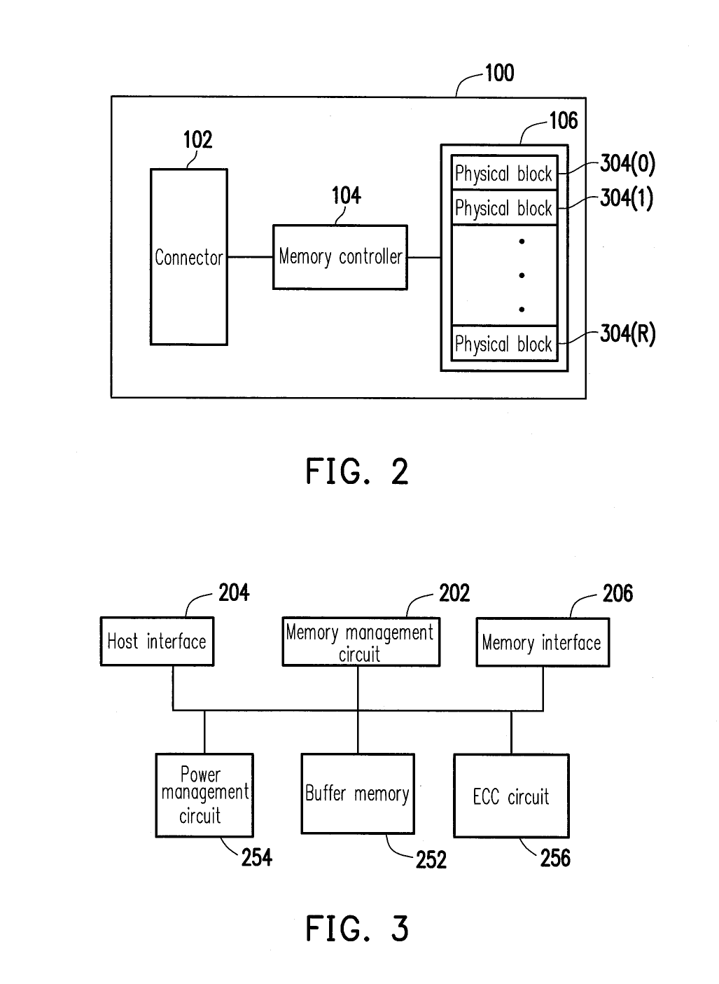

FIG. 2 is a schematic block diagram illustrating the memory storage device depicted in FIG. 1A.

With reference to FIG. 2, the memory storage device 100 includes a connector 102, a memory controller 104, and a rewritable non-volatile memory module 106.

In the present exemplary embodiment, the connector 102 complies with the serial advanced technology attachment (SATA) standard. However, the present invention is not limited thereto, and the connector 102 may comply with the parallel advanced technology attachment (PATA) standard, the Institute of Electrical and Electronic Engineers (IEEE) 1394 standard, the peripheral component interconnect (PCI) express standard, the universal serial bus (USB) standard, the secure digital (SD) standard, the ultra high speed-I (UHS-I), ultra high speed-II (UHS-II), the memory sick (MS) standard, the multi media card (MMC) standard, the compact flash (CF) standard, the integrated device electronics (IDE) standard, or other suitable standards.

The memory controller 104 is configured for executing a plurality of logic gates or control commands which are implemented in a hardware form or in a firmware form and performing operations such as data writing, data reading or data erasing in the rewritable non-volatile memory module 106 according to the command of the host system 1000.

The rewritable non-volatile memory module 106 is coupled to the memory controller 104 and configured to store the data written by the host system 1000. The rewritable non-volatile memory module 106 includes a plurality of physical blocks 3304(0)-304(R). For instance, the physical blocks 304(0)-304(R) can belong to the same memory die or different memory dies. Each of the physical blocks includes a plurality of physical pages, and each of the physical pages includes at least a physical sector, wherein the physical pages belonging to the same physical block can be written independently and erased simultaneously. For instance, each of the physical blocks is composed of 128 physical pages, and each of the physical pages includes 8 physical sectors. Namely, in the example where each of the physical sectors is 512 bytes, the capacity of each physical page is 4 Kilobytes (KBs). However, it should be known that the present invention is not limited thereto, and each of the physical blocks may also be composed of 64, 256, or any other number of physical pages.

In detail, a physical block is the minimum unit for erasing. That is to say, each of the physical blocks has a minimum number of memory cells for being erased altogether. A physical page is the minimum unit for programming. In other words, a physical page is the minimum unit for writing the data. However, it should be understood that in another embodiment of the present invention, the minimum unit for writing the data may also be a sector or other sizes. Each physical page usually includes a data bit area and a redundant bit area. The data bit area is configured to store user data, and the redundant bit area is used for storing system data (e.g., error checking and correcting (ECC) codes).

In the present exemplary embodiment, the rewritable non-volatile memory module 106 is a multi level cell (MLC) NAND flash memory module, i.e. the data of at least 2 bytes is stored in a memory cell. However, the present invention is not limited thereto. The rewritable non-volatile memory module 106 may also be a single level cell (SLC) NAND flash memory module, trinary level cell (TLC) NAND flash memory module, other flash memory modules or other memory modules with the same characteristics.

FIG. 3 is a schematic block diagram illustrating a memory controller according to an exemplary embodiment of the present invention.

Referring to FIG. 3, the memory controller 104 includes a memory management circuit 202, a host interface 204 and a memory interface 206.

The memory management circuit 202 is configured to control the whole operation of the memory controller 104. Particularly, the memory management circuit 202 has a plurality of control commands, and when the memory storage device 100 is operated, the control commands are executed to perform an operation such as, data writing, data reading, data erasing, and so on.

In the present exemplary embodiment, the control commands of the memory management circuit 202 are implemented in a firmware form. For example, the memory management circuit 202 includes a microprocessor unit (not shown) and a read-only memory (ROM, not shown), and the control commands are burning recorded in the read-only memory. When the memory storage device 100 is operated, the control commands are executed by the microprocessor unit to perform the operation, such as data writing, data reading, data erasing and so on.

In another exemplary embodiment of the present invention, the control commands of the memory management circuit 202 may also be stored in a specific area (for example, a system area in a memory module exclusively used for storing system data) of the rewritable non-volatile memory module 106 as a programming code. Moreover, the memory management circuit 202 includes a microprocessor unit (not shown), a read-only memory (ROM, not shown) and a random access memory (not shown). Particularly, the ROM has a driver code, and when the memory controller 104 is enabled, the microprocessor unit executes the driver code to load the control commands of the memory management circuit 202 stored in the rewritable non-volatile memory module 106 into the RAM of the memory management circuit 202. The microprocessor unit then executes the control commands to perform the operation, such as data writing, data reading, and data erasing.

Furthermore, as in another exemplary embodiment, the control commands of the memory management circuit 202 may also be implemented in a form of hardware. For example, the memory management circuit 202 includes a micro controller, a memory cell management circuit, a memory writing circuit, a memory reading circuit, a memory erasing circuit and a data processing circuit. The memory cell management circuit, the memory writing circuit, the memory reading circuit, the memory erasing circuit and the data processing unit are coupled to the micro controller. Therein, the memory cell management circuit is configured for managing the physical blocks of the rewritable non-volatile memory module 106. The memory writing circuit is configured to give the write command to the rewritable non-volatile memory module 106 in order to write the data into the rewritable non-volatile memory module 106. The memory reading circuit is configured to give the read command to the rewritable non-volatile memory module 106 in order to read the data from the rewritable non-volatile memory module 106. The memory erasing circuit is configured to give the erase command to the rewritable non-volatile memory module 106 in order to erase the data in the rewritable non-volatile memory module 106. The data processing unit is configured to process the data which is to be written into the rewritable non-volatile memory module 106 or the data read from the rewritable non-volatile memory module 106.

The host interface 204 is coupled to the memory management circuit 202 and configured to receive and identify the commands and the data transmitted by the host system 1000. Namely, the commands and data transmitted by the host system 1000 are sent to the memory management circuit 202 through the host interface 204. In the present exemplary embodiment, the host interface 204 complies with the SATA standard. However, the present invention is not limited thereto, and the host interface 204 may also comply with the PATA standard, the IEEE 1394 standard, the PCI Express standard, the USB standard, the SD standard, the MS standard, the MMC standard, the CF standard, the IDE standard, or any other appropriate data transmission standard.

The memory interface 206 is coupled to the memory management circuit 202 for accessing the rewritable non-volatile memory module 106. In other words, the data to be written to the rewritable non-volatile memory module 106 is converted to an acceptable format for the rewritable non-volatile memory module 106 by the memory interface 206.

In an exemplary embodiment of the present invention, the memory controller 104 further includes a buffer memory 252, a power management circuit 254 and an error checking and correcting circuit 256.

The buffer memory 252 is coupled to the memory management circuit 202 and configured to temporarily store the data and commands from the host system 1000 or the data from the rewritable non-volatile memory module 106.

The power managing circuit 254 is coupled to the memory management circuit 202 and configured to control the power of the memory storage device 100.

The error checking and correcting circuit 256 is coupled to the memory management circuit 202 and configured to perform an error checking and correcting process to ensure the accuracy of data. To be more specific, when the memory managing 202 receives a write command from the host system 1000, the error checking and correcting circuit 256 generates an error checking and correcting code (ECC code) corresponding to the data of the write command, and the memory management circuit 202 writes the data corresponding to the write command and the corresponding ECC code into the rewritable non-volatile memory module 106. Afterward, when the memory management circuit 202 reads the data from the rewritable non-volatile memory module 106, the corresponding ECC code is also read, and the error checking and correcting circuit 256 executes the error checking and correcting process on the read data according to the ECC code.

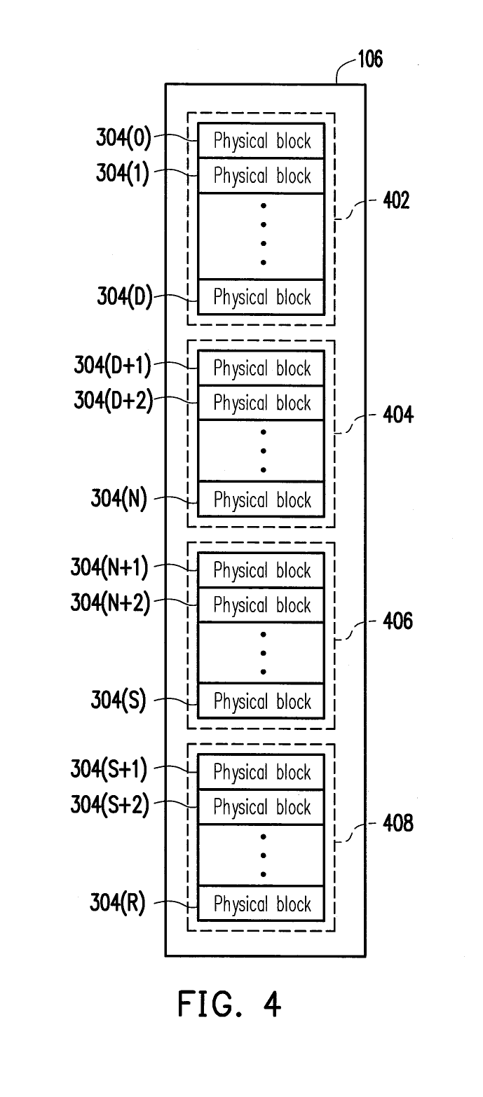

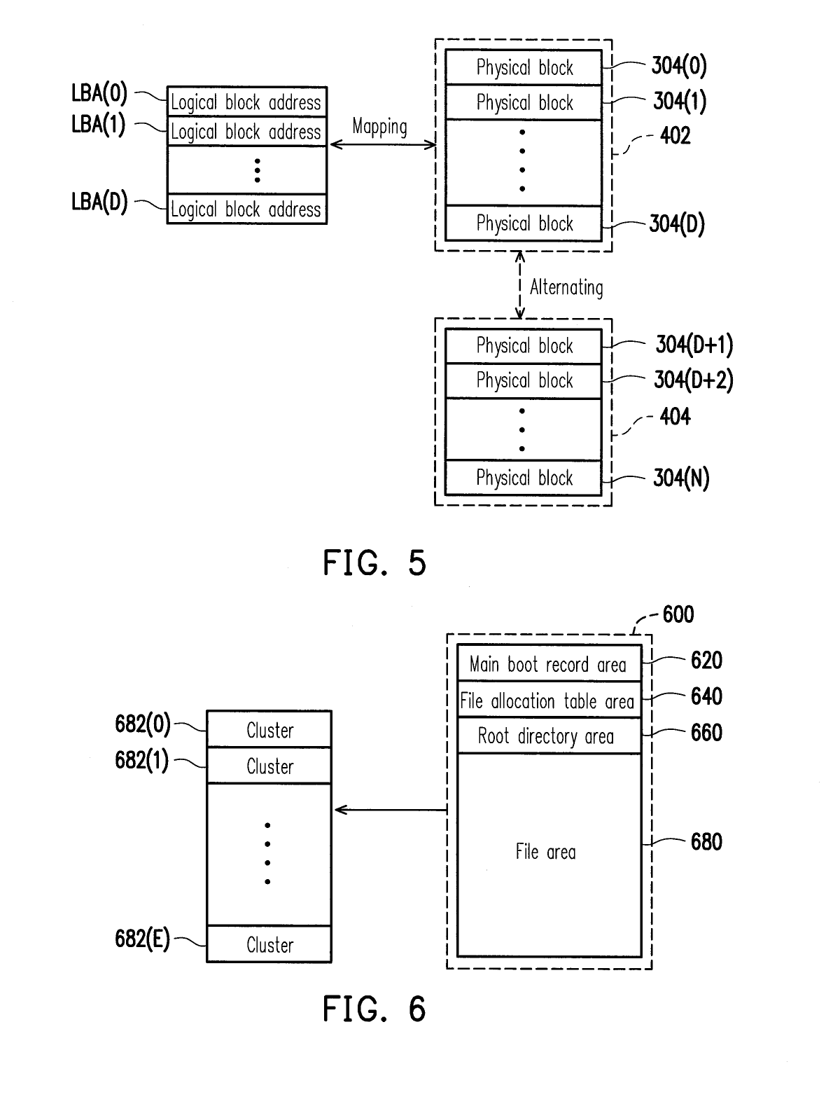

FIGS. 4 and 5 are schematic diagrams illustrating examples of managing a rewritable non-volatile memory module according to an exemplary embodiment of the present invention.

It should be noticed that the terms used for describing operations on the rewritable non-volatile memory module 106 such as “get”, “exchange”, “group” and “alternate”, etc. for operating the physical blocks of the rewritable non-volatile memory module 106 are only logical concepts. Namely, actual positions of the physical blocks of the rewritable non-volatile memory module are not changed, and the physical blocks of the rewritable non-volatile memory module are only operated logically.

Referring to FIG. 4, the memory controller 104 logically groups the physical blocks 304(0)-304(R) of the rewritable non-volatile memory module into areas, such as, a data area 402, a spare area 404, a system area 406 and a replacement area 408. In the present embodiment, the spare area 404 and the replacement area 408 are collectively referred to as a second area, and in other words, the second area includes the spare area 404 and the replacement area 408. In another exemplary embodiment, the spare area 404 and the replacement area 408 commonly share the physical blocks containing invalid data.

The physical blocks of the data area 402 and the spare area 404 are used to store the data from the host system 1000. To be specific, the data area 402 are physical blocks which have been used to store data, and the spare area 404 are physical blocks which are used to substitute the physical blocks of the data area 402. Hence, the physical blocks of the spare area 404 are either blank or available blocks. That is, no data is recorded therein or data recorded therein is marked as the invalid data not is use. That is, the physical blocks of the spare area 404 have been performed by an erasing operation, or the gotten physical block needs to be performed by the erasing operation first before a physical block of the spare area 404 is gotten for storing data. Hence, the physical blocks of the spare area 404 are available physical blocks.

The physical blocks logically belonging to the system area 406 are used for recording system data, which includes information related to the manufacturer and a model of a memory chip, the number of the zones in each memory chip, the number of the physical blocks in each zone, the number of the physical pages in each physical block, and so forth.

The physical blocks logically belonging to the replacement area 408 are replacement physical blocks. For example, when the rewritable non-volatile memory module is manufactured in the factory, 4% of the physical blocks thereof are reserved for replacement. Namely, when any physical block in the data area 402, the spare area 404, and the system area 406 is damaged, a physical block in the replacement area 408 is used for replacing the damaged physical block (i.e., the bad block). Thus, if there are still normal physical blocks in the replacement area 408, and a physical block is damaged, the memory management circuit 104 gets a normal physical block from the replacement area 408 for replacing the damaged physical block. If there is no more normal physical block in the replacement area 408, and a physical block is damaged, the memory storage device 100 is announced as being in a write-protect status by the memory controller 104 and cannot be used for writing data anymore.

Specially, the numbers of physical blocks in the data area 402, the spare area 404, the system area 406 and the replacement area 408 are various based on different memory modes. Additionally, it is to be understood that the grouping relationships associated with the data area 402, the spare area 404, the system area 406 and the replacement area 408 are dynamically changed during the operation of the memory storage device 100. For example, when a physical block of the spare area 404 is damaged and replaced by a physical block of the replacement area, the physical block of originally in the replacement is associated with the spare area.

Referring to FIG. 5, as described above, the physical blocks of the data area 402 and the spare area 404 are alternated to store data written by the host system 1000. In the present exemplary embodiment, the memory management circuit 104 configures logical block addresses LBA(0)-LBA(D) to access data in the physical blocks that store data in the above-mentioned alternate manner. For instance, when the memory storage device 100 is formatted by an operation system 1105, the logical blocks LBA(0)-LBA(D) are mapped to physical blocks 304(0)-304(D) in the data area 402. Herein, the memory management circuit 202 creates a logical block address-physical block mapping table for recoding a mapping relationship between the logical block address and the physical block. Each of the logical block addresses LBA(0)-LBA(D) may also includes a plurality of logical addresses for being accessed by the host system 1000. For example, a logical block address includes a storage space of 1 megabyte (MB), and each of the logical addresses includes a storage space of 4 kilobyte (KB). Thus, a logical block address includes 250 logical addresses. However, the present invention is not intent to limit the sizes of the logical block address and the storage space contained in the logical address.

It is to be noted that in the present exemplary embodiment, a physical block is also referred to as a physical unit union, a physical page set is also referred to as a physical unit set, and a physical page is also referred to as a physical unit. A logical block is also referred to as a logical unit union, a logical page set is also referred to as a logical unit set, and a logical page is also referred to as a logical unit. However, in other exemplary embodiments, the physical unit may also be one or more other electrical elements having rewritable and non-volatile characteristics, for example, a physical sector. The present invention is not limited thereto, and the logical unit is configured corresponding to the physical unit.

On the other hand, if a programming error occurs or a physical block is determined as damaged when the memory management circuit 202 programs the physical unit, a physical block in the second area (e.g. the replacement area 408) is used to replace the abnormal physical block (e.g. the physical block with the occurred programming error or the damaged physical block). Specifically, if there is no normal physical block available in the second area, the memory management circuit 202 gets a spare physical block from the data area 402 for replacing the abnormal physical block. The physical block in the data area 402 is mapped to a logical block address provided to the host system 1000, and thus, in an exemplary embodiment, the memory management circuit 202 creates an invalid file in a file system and maps the invalid file to the logical block address mapped to the abnormal physical block. For instance, the memory management circuit 202 sets the invalid file as inaccessible, and thus, the host system 1000 is not allowed to access the abnormal physical block. Accordingly, even though there is no replaceable physical block in the second area, the rewritable non-volatile memory module 106 still can be normally operated, and thus, the lifespan of the rewritable non-volatile memory module 106 can be prolonged. In another exemplary embodiment, the memory management circuit 202 may not create the invalid file, and instead, directly sets the logical block address mapped to the abnormal physical block as inaccessible, but creating the invalid file or not is not construed as the limitation to the present invention.

FIG. 6 is a schematic diagram illustrating an example of a file system according to an exemplary embodiment of the present invention.

Referring to FIG. 6, when the memory storage device 100 is formatted by the operation system 1105 of the host system 1000, the logical block addresses LBA(0)-LBA(D) are managed by a file system (e.g. a file allocation table (FAT), a high performance file system (HPFS) or a new technology file system (NTFS). For example, in the FAT file system, the logical block addresses LBA(0)-LBA(H) are partitioned into a partition area 600, and the partition area 600 includes a main boot record area 620, a file allocation table area 640, a root directory area 660, and a file area 680.

The logical addresses belonging to the main boot record area 620 are configured to store system information about the available storage spaces of the memory storage device 100.

The logical addresses belonging to file allocation table area 640 are configured to store file allocation tables. A file allocation table is configured to record clusters corresponding to the logical addresses for storing files. For example, two file allocation tables are stored in the file allocation table area 640, and one of the file allocation tables is configured for normal access, and the other file allocation table is configured for backup.

The logical block addresses belonging to the root directory area 660 is configured to store file description blocks (FDBs) which are configured to record the property information of files and directories currently stored in the memory storage device 100. In particular, in the file description blocks, initial storage addresses for storing the files (i.e., initial clusters) are recorded.

The storage addresses belonging to the file area 680 are configured to actually store the content of files.

To be more specific, a minimum storage unit of a disk is a sector, and each of the sectors includes the information content within 512 bytes. However, when employing the sector for storage, the efficiency of the host system 1000 becomes worse. Generally speaking, the operation system 1105 of the host system 1000 takes a cluster as a basic unit for file accessing rather than a sector. Each cluster is constructed of a power of 2 of the sectors. Given that one cluster is constructed of 8 continuous sectors, and then the size of the cluster is 4096 bytes. Accordingly, when accessing data, the operating system 1105 continuously reads data with 8 sectors to enhance the efficiency relatively. However, the cluster size is not the larger the better because when the cluster size is larger, the wasted storage spaces will be more. For example, when the size of one cluster is 4 KB, and the size of a file stored by the host system 1000 is only 1 KB, the file still occupies the storage spaces of one cluster, and the rest storage spaces of 3 KB would be wasted. Specially, the total of clusters is limited by and varied based on the capacity of the rewritable non-volatile memory module and the type of the file allocation table (FAT). Taking the FAT 16 as an example, the maximum number of clusters must be within a range of 4048-65526 according the definition of FAT16, and therefore, when a memory card having storage spaces of 128 MB is formatted, each cluster must include at least 4 sectors; otherwise the number of clusters in the memory card will exceed its limitation of 65526 clusters (i.e., 127901/512/4=62452 clusters). Therefore, the size of each cluster is 2 KB. Similarly, in the FAT32, the maximum number of clusters must be within a range of 65526-4177918. It should be noted that in the FAT 16, the size of the root directory area 660 is fixed. Instead, in the FAT32, the root directory area 660 is configured in the file area 680 to be managed together.

For example, in the present exemplary embodiment, the partition area 600 is a partition complied with the standard of the FAT 32. Therefore, the sectors belonging to the root directory area 660 and the file area 680 are grouped into clusters 682(0)-682(E). Herein, it is assumed that the cluster 682(0) is configured as an initial cluster of the root directory area 660.

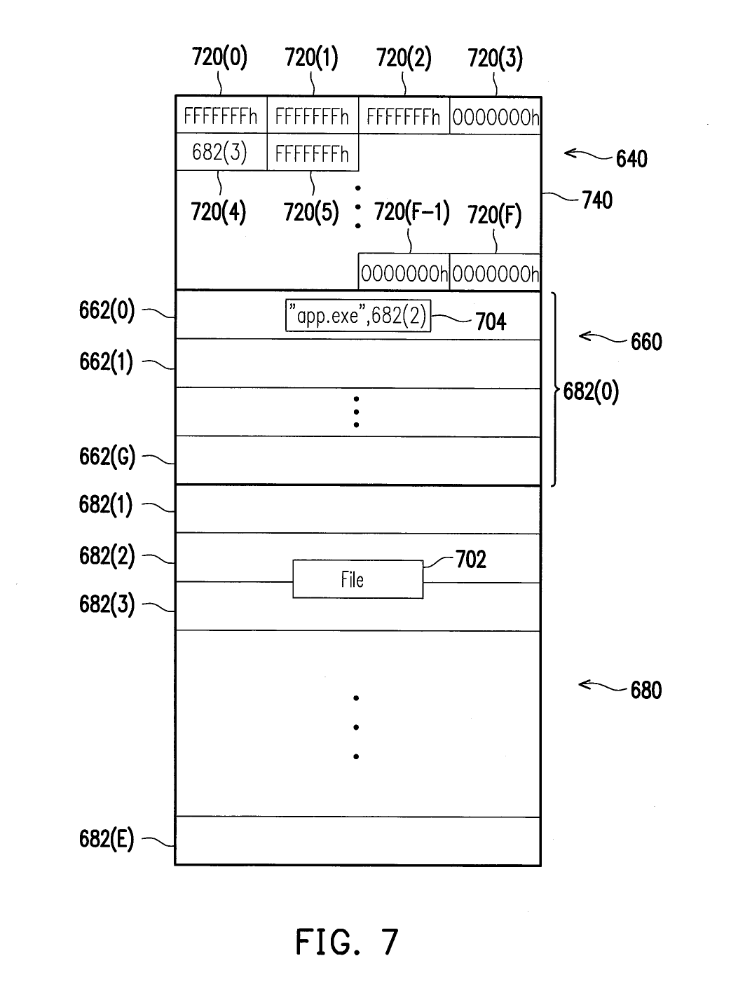

FIG. 7 is a schematic diagram illustrating an example of a file allocation table area, a root directory area and a file area according to an exemplary embodiment of the present invention.

Referring to FIG. 7, the file allocation table area 640 at least includes a file allocation table 740, and the file allocation table 740 has cluster entry fields 720(1)-720(F). Herein, the cluster entry field 720(0) and the cluster entry fields 720(1) are reserved and filled with predetermined values. Moreover, each of the cluster entry fields started from the cluster entry field 720(2) corresponds to one of the clusters 682(2)-682(E). For example, the cluster entry field 720(2) corresponds to the cluster 682(0), the cluster entry field 720(3) corresponds to the cluster 682(1), and the others do likewise. The cluster entry fields corresponding to the clusters are respectively filled with a cluster entry to represent a link relationship of the clusters.

Here, the cluster entry of the cluster entry field uses special characters to represent a state of the cluster corresponding thereto. For example, in the FAT32, when the cluster entry field is filled with “0000000h”, it represents that the cluster is a spare cluster (i.e. a cluster storing no data). For example, the cluster 682(1) corresponding to the cluster entry field 720(3) is a spare cluster, and thus, the cluster entry in the cluster entry field 720(3) is “0000000h”. In addition, when the cluster entry field is filled with “FFFFFF8h”-“FFFFFFFh”, it represents that the cluster is the last cluster of the stored file. Here, “FFFFFF8h”-“FFFFFFFh” are also referred to as end of clusterchain marks (EOC marks), and for example, the content recorded in the cluster entry field 720(2) is the EOC mark. Further, when one cluster entry field is filled with a logical address of one cluster, it represents that such cluster continues to store data in a following cluster corresponding to the cluster entry field. For example, a cluster entry recorded in the cluster entry field 720(4) is the cluster 682(3), it represents that the cluster 682(3) continues to store data of the corresponding file by following the cluster 682(2). Accordingly, according to the information in the cluster entry fields 720(4) and 720(5), the operation system 1105 is aware that a certain file 702 is sequentially stored in the clusters 682(2) and 682(3).

The root directory area 660 includes directory entry fields 662(0)-662(G), and each of the directory entry fields is used to store a file description block (FDB). Meanwhile, a FDB is configured to record information of a file, such as a file name, a file extension, and an initial cluster. For example, the directory entry field 662(0) stores a FDB 704 belonging to the file 702. The FDB 704 records the file name and the file extension of the file 702 as “app” and “.exe”, respectively and also records the initial cluster as the cluster 682(2). Therefore, according to the information in the file allocation table area 640 and the root directory area 660, the operation system 1105 is aware that a file named “app.exe” is stored in the memory storage device 100, the initial cluster of the file is the cluster 682(2), and the file is sequentially stored in the cluster 682(2) and cluster 682(3).

In addition, in the present exemplary embodiment, the root directory area 660 is stored in the cluster 682(0). However, it should be noted, in the FAT 32, the root directory area 660 is managed together with the file area 680. Therefore, the clusters belonging to the root directory area 660 may be dynamically expanded to record more file description blocks, such that the number of files that can be stored in the memory storage device 100 is not limited. For example, if the root directory area 660 is recorded in the cluster 682(0) and the cluster 682(1), the cluster entry of the cluster entry field 720(2) is “682(1)”, and the cluster entry of the cluster entry fields 720(3) is “FFFFFFFh”. The present invention is not intent to limit the number of clusters stored in the root directory area 660.

In the present exemplary embodiment, a logical block address includes two clusters. For example, the clusters 682(0) and 682(1) belong to a same logical block address, while the clusters 682(2) and 682(3) belong to another logical block address. The host system 1000 gives a command of accessing the logical block address to the memory management circuit 202 based on the file system, as shown in FIG. 7. For example, the host system 1000 first reads the root directory area 660 and the file allocation table 740 to learn that the file 702 is stored in the cluster 682(2) and cluster 682(3). When the host system 1000 is to write data to the file 702, a logical block address (hereinafter as a first logical block address) belonging to the cluster 682(2) and the cluster 682(3) is obtained. Then, the host system 1000 gives a command of writing data to the first logical block address to the memory management circuit 202. However, in other exemplary embodiments, one logical block address may also include more or fewer clusters, and the present invention is not limited thereto.

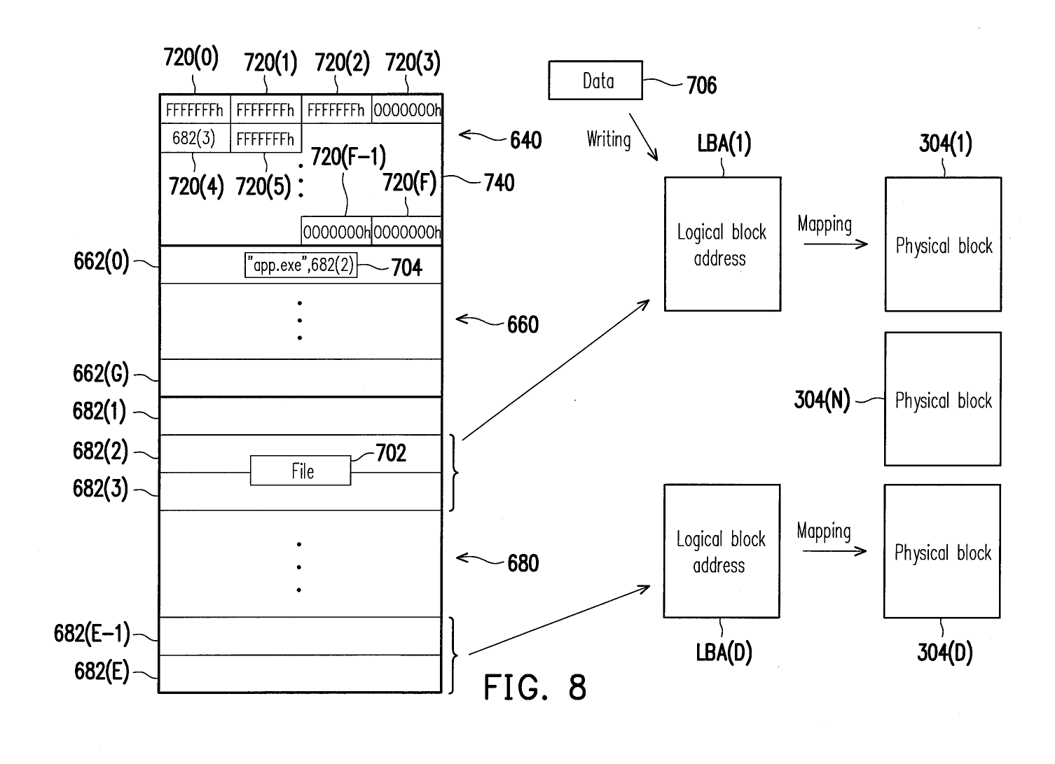

FIG. 8 is a schematic diagram illustrating an example of creating an invalid file according to an exemplary embodiment of the present invention.

Referring to FIG. 8, the file 702 is logically stored in the clusters 682(2) and 682(3). The clusters 682(2) and 682(3) belong to the logical block address LBA(1) (i.e. the first logical block address), and the logical block address LBA(1) is mapped to the physical block 304(1) (i.e. the first physical block). That is to say, the file 702 is substantially stored in the physical block 304(1), and the host system 1000 may access the file 702 via accessing the logical block address LBA(1).

When the host system 1000 is to update the file 702 according to data 706, the memory management circuit 202 receives from the host system 1000 a write command instructing to write the data 706 to the logical block address LBA(1). However, since one physical block needs to be erased before programming a new data, the memory management circuit 202 programs the data 706 to the physical block 304(N) (i.e. the third physical block) in the second area (e.g. the spare area 404). Besides, when writing the data 706 to the physical block 304(N) according to the write command, the memory management circuit 202 determines whether a programming error occurs. If no programming error occurs, the memory management circuit 202 copies valid data in the physical block 304(1) to the physical block 304(N), remaps the logical block address LBA(1) to the physical block 304(N) and associates the physical block 304(1) with the spare area 404. In another exemplary embodiment, the data 706 belongs to a new file, and there is no valid data corresponding to the new file in the physical block 304(1). Therefore, in another exemplary embodiment, the memory management circuit 202 only remaps the logical block address LBA(1) to the physical block 304(N) and associates the physical block 304(1) with the spare area 404.

Otherwise, if a programming error occurs when programming the data 706 to the physical block 304(N), the memory management circuit 202 gets a writable physical block (i.e. a fourth physical block) from the second area (e.g. the replacement area 408) for replacing the physical block 304(N). Specially, if there is no writable physical block existing in the second area, the memory management circuit 202 gets a spare physical block from the data area 402 for replacing the physical block 304(N). In particular, the memory management circuit 202 first searches among the cluster entry fields 720(0)-720(F) for a spare cluster entry field (i.e. a second cluster entry field). For example, the memory management circuit 202 gets the cluster entry fields 720(F-1) and 720(F) corresponding to the cluster entry of “0000000h”. The cluster entry fields 720(F-1) and 720(F) respectively correspond to the clusters 682(E-1) and 682(E), and the clusters 682(E-1) and 682(E) belong to the logical block address LBA(D) (i.e. a second logical block address). Meanwhile, the logical block address LBA(D) is mapped to a physical block 304(D) (i.e. a second physical block). In other words, the memory management circuit 202 gets the physical block 304(D) storing no data from the data area 402.

In the present exemplary embodiment, the physical block 304(D) is used for replacing the physical block 304(N) where the programming error occurs. Specially, in an exemplary embodiment, the memory management circuit 202 creates an invalid file and sets the invalid file to be accessed via the logical block address LBA(D). Additionally, the memory management circuit 202 maps the logical block address LBA(D) to the physical block 304(N). Namely, the invalid file created by the memory management circuit 202 is indirectly mapped to the physical block 304(N). For example, the memory management circuit 202 sets the invalid file as inaccessible so that the host system 1000 is not allowed to access the physical block 304(N). However in other exemplary embodiments, the invalid file may also be set as accessible, but the present invention is not limited thereto.

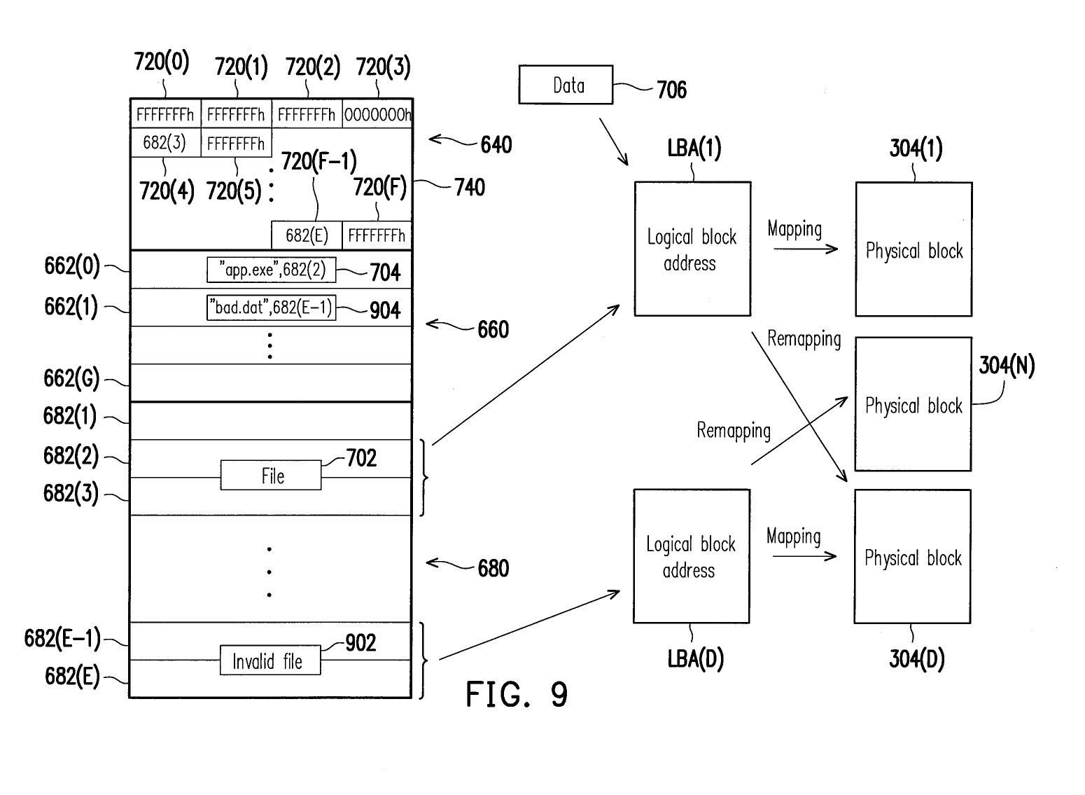

FIG. 9 is a schematic diagram illustrating an example of recording a file description block corresponding to an invalid file in a directory entry field according to an exemplary embodiment of the present invention.

For example, referring to FIG. 9, the memory management circuit 202 creates an invalid file 902 and sets the invalid file 902 as logically stored in the clusters 682(E-1) and 682(E). Namely, the memory management circuit 202 allocates the spare cluster entry fields 720(F-1) and 720(F) to the invalid file 902. And, the memory management circuit 202 sets the cluster entry corresponding to the cluster entry fields 720(F-1) as “682(E)” and sets the cluster entry corresponding to the cluster entry fields 720(F) as “FFFFFFFh” to represent that the invalid file 902 is stored in the clusters 682(E-1) and 682(E). In other words, based on the aforementioned settings, the invalid file 902 is accessed through the logical block address LBA(D). Additionally, the memory management circuit 202 further creates a file description block 904 corresponding to the invalid file 902 and records the file description block 904 in the directory entry field 662(1). The memory management circuit 202 sets the file description block 904 to include a file name (e.g. “bad”), an extension (e.g. “.dat”) and a initial cluster 682(E-1) of the invalid file 902. Specially, the memory management circuit 202 is configured to remap the logical block address LBA(D) which is used to access invalid file 902 to the physical block 304(N). In an exemplary embodiment, the memory management circuit 202 further sets the invalid file 902 as inaccessible. For example, the memory management circuit 202 configures the logical block address LBA(D) as inaccessible. Accordingly, when the host system 1000 is to access the logical block address LBA(D), the memory management circuit 202 sends an access error message to the host system 1000. Thereby, the host system 1000 is not allowed to access physical block 304(N) with the occurred programming error. It should be noted that, the host system 1000 at this time is not aware that the programming error occurs in the physical block 304(N), but the host system merely recognizes that there is an additional valid file 902 in the file system of the memory storage device 100.

Afterward, the memory management circuit 202 completes writing the data 706. Particularly, the memory management circuit 202 obtains the physical block 304(D) originally mapped to the logical block address LBA(D) and copies the valid data in the physical block 304(1) to the physical block 304(D). Then, the memory management circuit 202 writes the data 706 to the physical block 304(D) and remaps the logical block address LBA(1) to the physical block 304(D). Accordingly, the host system 1000 recognizes that the data 706 is successfully written into the physical block mapped to the logical block address LBA(1).

In the exemplary embodiment, during the process of the memory management circuit 202 searching for spare cluster entry fields among the cluster entry fields 720(0)-720(F), the memory management circuit 202 obtains multiple cluster entry fields, which are continuous, spare and has storage spaces matching one logical block address. For example, the cluster entry fields 720(F-1) and 720(F) are cluster entry fields that are continuous, spare and have storage spaces matching the logical block address LBA(D). That is to say, the memory management circuit 202 gets and configures the continuous clusters 682(E-1) and 682(E) to logically store the invalid data. However, in another exemplary embodiment, the memory management circuit 202 may also obtain multiple cluster entry fields that are discontinuous but spare. Besides, the memory management circuit 202 obtains a spare logical block address to store the invalid file through a data merge and a data move operations. The present invention is not intent to limit the cluster entry fields and the clusters to being continuous or discontinuous.

Furthermore, during the process of the memory management circuit 202 searching for spare cluster entry fields, if no cluster entry field that is spare and has storage spaces matching a logical block address is found, it represents that there is no unused physical blocks in the data area 402. That also represents that in the rewritable non-volatile memory module 106, there is no spare physical block for replacing the physical block where the programming error occurs, and thus, the memory management circuit 202 executes a card locking procedure on the rewritable non-volatile memory module 106. The card locking procedure is configured to forbid executing a writing operation on the rewritable non-volatile memory module 106.

Additionally, in the present exemplary embodiment, the file description block 904 corresponding to the invalid file 902 is recorded in one of the directory entry fields 662(0)-662(G). However, in another exemplary embodiment, the memory management circuit 202 may also create an invalid file directory configured to record all file description blocks corresponding to all invalid files.

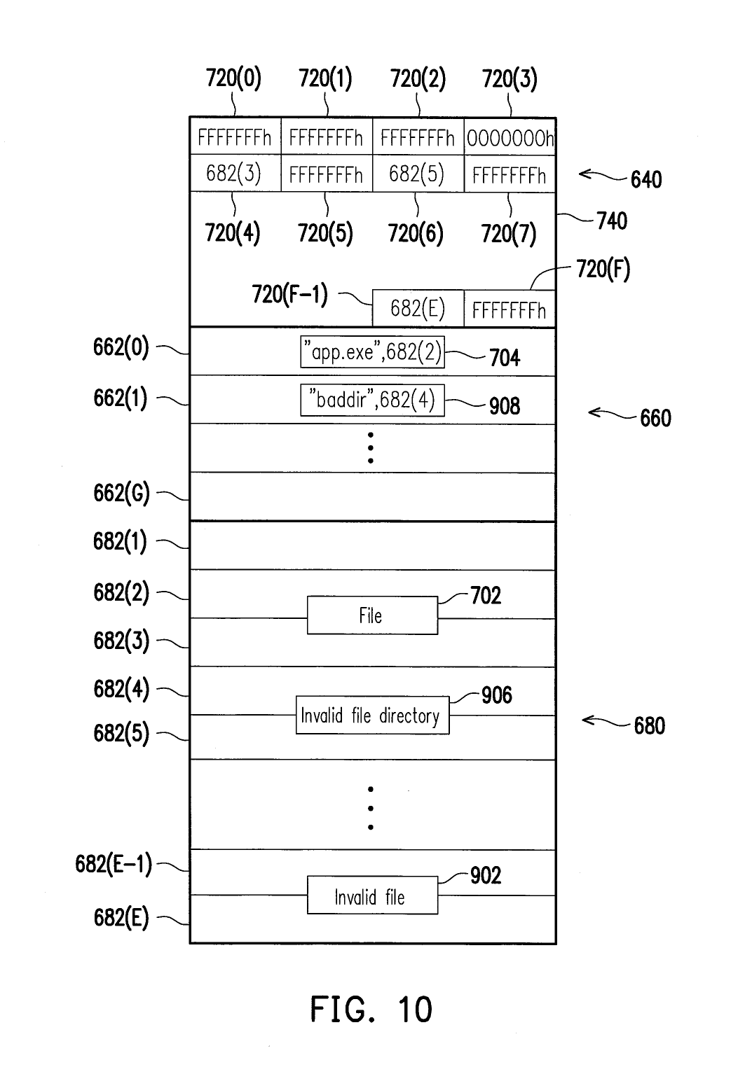

FIG. 10 is a schematic diagram illustrating an example of creating an invalid file according to another exemplary embodiment of the present invention.

Referring to FIG. 10, in the exemplary embodiment illustrated in FIG. 10, the memory management circuit 202 creates an invalid file directory 906 in the clusters 682(4) and 682(5) and correspondingly modifies the cluster entry fields 720(6) and 720(7). Besides, the memory management circuit 202 creates a file description block 908 corresponding to the invalid file directory 906 and records the file description block 908 in the directory entry field 662(1). Specially, after creating the file description block corresponding to the invalid file 902, the memory management circuit 202 also records the file description block 908 corresponding to the invalid file 902 in the invalid file directory 906. Namely, in the invalid file directory 906, the file description blocks corresponding to all invalid files are recorded, such that the situation where each invalid file occupies a directory entry field will not happen. In the present exemplary embodiment, the invalid file directory 906 occupies two clusters. However, in other exemplary embodiments, the invalid file directory 906 may occupies a number of more or fewer clusters, and the present invention is not limited thereto.

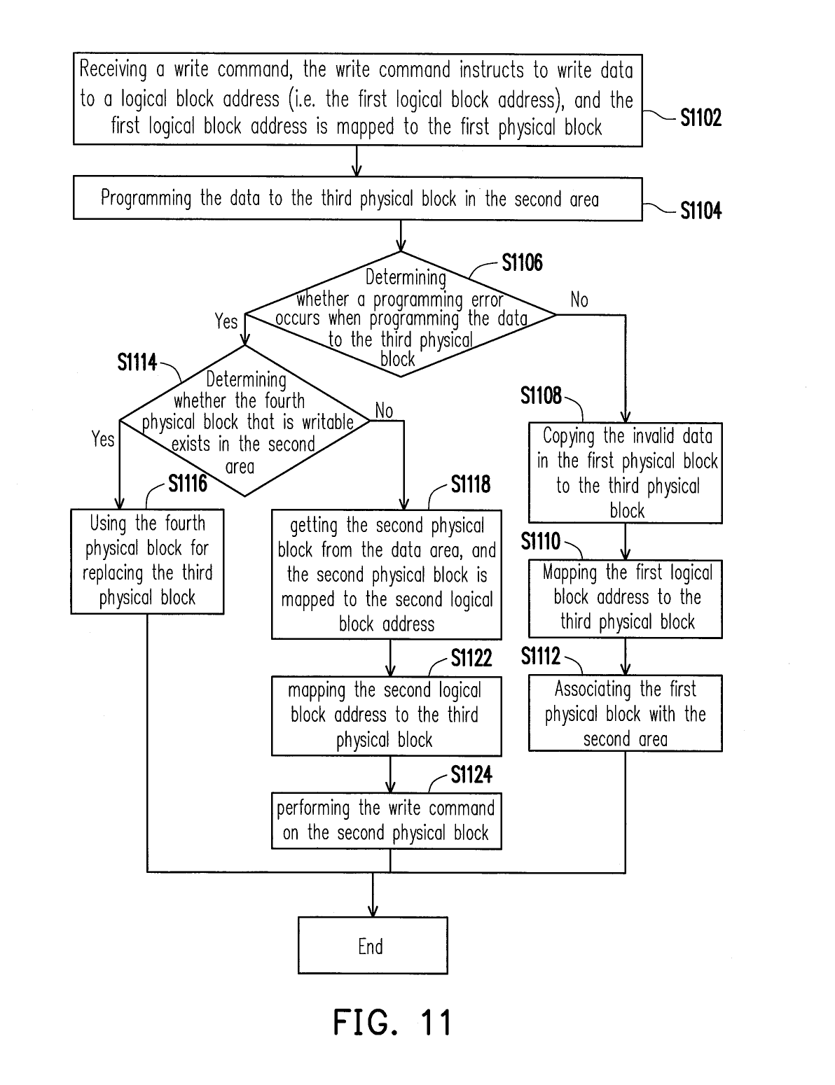

FIG. 11 is a flowchart illustrating a block management method according to an exemplary embodiment of the present invention.

Referring to FIG. 11, in step S1102, the memory management circuit 202 receives a write command. The write command instructs to write data to one logical block address (i.e. the first logical block address), and the first logical block address is mapped to the first physical block. In step S1104, the memory management circuit 202 programs the data to the third physical block in the second area according to the write command. In step S1106, the memory management circuit 202 determines whether a programming error occurs when programming the data to the third physical block.

If no programming error occurs, in step S1108, the memory management circuit 202 copies the invalid data in the first physical block to the third physical block. In step S1110, the memory management circuit 202 maps the first logical block address to the third physical block. In step S1112, the memory management circuit 202 associates the first physical block with the second area (e.g. the spare area 404) and associates the second physical block with the data area 402.

If the programming error occurs, in step S1114, the memory management circuit 202 determines whether the fourth physical block that is writable exists in the second area (e.g. the replacement area 408). If the fourth physical block exists, in step S1116, the memory management circuit 202 uses the fourth physical block for replacing the third physical block.

If the fourth physical block does not exist, in step S1118, the memory management circuit 202 gets the second physical block from the data area 402, and the second physical block is mapped to the second logical block address. In step S1122, the memory management circuit 202 maps the second logical block address to the third physical block.

In step S1124, the memory management circuit 202 performs the write command on the second physical block. For example, the memory management circuit 202 copies valid data in the first physical block to the second physical block and writes the data to the second physical block according to the write command. The memory management circuit 202 further remaps the first logical block address to the second physical block, associates the first physical block with the second area and associates the second physical block with the data area 402. Herein, steps S1114, S1116, S1118, S1122 and S1124 are collectively referred to as a first procedure. However, each step illustrated in FIG. 11 has been described as above, and will not be repeated hereinafter.

In view of the foregoing, through the memory control method, the memory storage device and the memory management circuit provided by the exemplary embodiments of the present invention, when the programming error occurs in the physical block, and there is no available physical block existing in the second area (e.g. the replacement area), the physical block in the data area can be used for replacing the physical block where the programming error occurs. Accordingly, the lifespan of the rewritable non-volatile memory module can be prolonged. The previously described exemplary embodiments of the present invention have the advantages aforementioned, wherein the advantages aforementioned not required in all versions of the present invention.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A memory management method for a rewritable non-volatile memory module comprising a plurality of physical unit unions, wherein the plurality of physical unit unions is at least partitioned into a data area and a second area, a plurality of logical unit union addresses is configured and mapped to the plurality of physical unit unions in the data area, and the plurality of logical unit union addresses is managed by a file system, the memory management method comprising:
receiving a write command, wherein the write command instructs to write data to a first logical unit union address among the plurality of the logical unit union addresses, wherein the first logical unit union address is mapped to a first physical unit union in the data area;
programming the data to a third physical unit union in the second area;
determining whether a programming error occurs when programming the data to the third physical unit union; and
executing a first procedure if the programming error occurs, wherein the first procedure comprises:
obtaining a second physical unit union from the data area, wherein the second physical unit union is mapped to a second logical unit union address among the plurality of logical unit union addresses; and
mapping the second logical unit union address to the third physical unit union.

2. The memory management method as claimed in claim 1, wherein the first procedure further comprises:
writing the data to the second physical unit union according to the write command;
remapping the first logical unit union address to the second physical unit union; and
associating the first physical unit union with the second area and associating the second physical unit union with the data area.

3. The memory management method as claimed in claim 1, wherein the first procedure further comprises:
copying valid data in the first physical unit union to the second physical unit union.

4. The memory management method as claimed in claim 1, wherein when the plurality of logical unit union addresses is configured, the plurality of physical unit unions in the second area is non-mappable to the plurality of logical unit union addresses, and each of the plurality of physical unit unions in the data area is mapped to one of the plurality of logical unit union addresses.

5. The memory management method as claimed in claim 1, wherein the first procedure further comprises:
creating an invalid file in the file system and setting the invalid file to be accessed by the second logical unit union address; and
setting the invalid file as inaccessible.

6. The memory management method as claimed in claim 5, wherein the file system comprises a file allocation table area, a root directory area and a file area, the file allocation table area has a plurality of cluster entry fields, wherein the root directory area has a plurality of directory entry fields, and the file area has a plurality of clusters, wherein each of the plurality of cluster entry fields records a cluster entry, and each of the plurality of clusters corresponds to one of the plurality of cluster entry fields, wherein the step of obtaining the second physical unit union from the data area comprises:
obtaining a plurality of second cluster entry fields from the plurality of the cluster entry fields, wherein the second cluster entry fields are spare and the plurality of clusters corresponding to the second cluster entry fields belong to the second logical unit union address;
allocating the second cluster entry fields to the invalid file and modifying the cluster entries recorded in the second cluster entry fields according to the invalid file; and
generating a file description block corresponding to the invalid file, wherein the file description block corresponding to the invalid file records an initial cluster storing the invalid file.

7. The memory management method as claimed in claim 6, wherein a step of creating the invalid file in the file system further comprises:
recording the file description block corresponding to the invalid file in one of the plurality of directory entry fields.

8. The memory management method as claimed in claim 6, wherein the step of creating the invalid file in the file system further comprises:
creating an invalid file directory and storing the invalid file directory in the plurality of clusters in the file area;
creating a file description block corresponding to the invalid file directory and recording the file description block corresponding to the invalid file directory in one of the plurality of directory entry fields; and
recording the file description block corresponding to the invalid file in the invalid file directory.

9. The memory management method as claimed in claim 6, wherein the step of obtaining the second cluster entry fields further comprises:
executing a card locking procedure on the rewritable non-volatile memory module when the second cluster entry fields do not exist in the plurality of cluster entry fields, wherein the card locking procedure is configured to forbid executing a writing operation on the rewritable non-volatile memory module.

10. The memory management method as claimed in claim 1, wherein the first procedure further comprises:
determining whether a fourth physical unit union which is writable exists in the second area.

11. A memory storage device, comprising:
a connector, configured to be coupled to a host system;
a rewritable non-volatile memory module, having a plurality of physical unit unions, wherein the plurality of physical unit unions is at least partitioned into a data area and a second area, a plurality of logical unit union addresses is configured and mapped to the plurality of physical unit unions in the data area, and the plurality of logical unit union addresses is managed by a file system; and
a memory controller, coupled to the connector and the rewritable non-volatile memory module,
wherein the memory controller is configured to receive a write command from a host system, wherein the write command instructs to write data to a first logical unit union address among the plurality of the logical unit union addresses, wherein the first logical unit union address is mapped to a first physical unit union in the data area,
wherein the memory controller is configured to program the data to a third physical unit union in the second area,
wherein the memory controller is configured to determine whether a programming error occurs when programming the data to the third physical unit union, and
wherein the memory controller is configured to obtain a second physical unit union from the data area if the programming error occurs, wherein the second physical unit union is mapped to a second logical unit union address among the plurality of logical unit union addresses, and the memory controller is configured to map the second logical unit union address to the third physical unit union.

12. The memory storage device as claimed in claim 11, wherein the memory controller is further configured to write the data to the second physical unit union according to the write command, remap the first logical unit union address to the second physical unit union, associate the first physical unit union with the second area and associates the second physical unit union with the data area.

13. The memory storage device as claimed in claim 11, wherein the memory controller is further configured to copy valid data in the first physical unit union to the second physical unit union.

14. The memory storage device as claimed in claim 11, wherein when the plurality of logical unit union addresses is configured, the plurality of physical unit unions in the second area is non-mappable to the plurality of logical unit union addresses, and each of the plurality of physical unit unions in the data area is mapped to one of the plurality of logical unit union addresses.

15. The memory storage device as claimed in claim 11, wherein the memory controller is further configured to create an invalid file in the file system, set the invalid file to be accessed by the second logical unit union address and set the invalid file as inaccessible.

16. The memory storage device as claimed in claim 15, wherein the file system comprises a file allocation table area, a root directory area and a file area, wherein the file allocation table area has a plurality of cluster entry fields, the root directory area has a plurality of directory entry fields, and the file area has a plurality of clusters, wherein each of the plurality of cluster entry fields records a cluster entry, and each of the plurality of clusters corresponds to one of the plurality of cluster entry fields,
wherein the memory controller is configured to obtain a plurality of second cluster entry fields from the plurality of the cluster entry fields, wherein the second cluster entry fields are spare and the plurality of clusters corresponding to the second cluster entry fields belong to the second logical unit union address,
wherein the memory controller is configured to allocate the second cluster entry fields to the invalid file and modify the cluster entries recorded in the second cluster entry fields according to the invalid file, and
wherein the memory controller is configured to generate a file description block corresponding to the invalid file, wherein the file description block corresponding to the invalid file records an initial cluster storing the invalid file.

17. The memory storage device as claimed in claim 16, wherein the memory controller is configured to record the file description block corresponding to the invalid file in one of the plurality of directory entry field.

18. The memory storage device as claimed in claim 16, wherein the memory controller is configured to create an invalid file directory and store the invalid file directory in the plurality of clusters in the file area,
wherein the memory controller is configured to create a file description block corresponding to the invalid file directory and record the file description block corresponding to the invalid file directory in one of the plurality of directory entry fields, and
wherein the memory controller is configured to record the file description block corresponding to the invalid file in the invalid file directory.

19. The memory storage device as claimed in claim 16, the memory controller is configured to execute a card locking procedure on the rewritable non-volatile memory module when the second cluster entry fields do not exist in the plurality of cluster entry fields, wherein the card locking procedure is configured to forbid executing an writing operation on the rewritable non-volatile memory module.

20. The memory storage device as claimed in claim 11, wherein the memory controller is further configured to determine whether a fourth physical unit union which is writable exists in the second area.

21. A memory controller, comprising:
a host interface, configured to be coupled to a host system;
a memory interface, configured to be coupled to a rewritable non-volatile memory module, wherein the rewritable non-volatile memory module comprises a plurality of physical unit unions, wherein the plurality of physical unit unions is at least partitioned into a data area and a second area, the plurality logical unit union addresses is configured and mapped to the plurality of physical unit unions in the data area, and the plurality of logical unit union addresses is managed by a file system; and
a memory management circuit, coupled to the host interface and the rewritable non-volatile memory module,
wherein the memory management circuit is configured to receive a write command from the host system, wherein the write command instructs to write data to a first logical unit union address among the plurality of the logical unit union addresses, wherein the first logical unit union address is mapped to a first physical unit union in the data area,
wherein the memory management circuit is configured to program the data to a third physical unit union in the second area,
wherein the memory management circuit is configured to determine whether a programming error occurs when programming the data to the third physical unit union, and
wherein if the programming error occurs, the memory management circuit is configured to obtain a second physical unit union from the data area, wherein the second physical unit union is mapped to a second logical unit union address among the plurality of logical unit union addresses, and the memory management circuit is configured to map the second logical unit union address to the third physical unit union.

22. The memory controller as claimed in claim 21, wherein the memory management circuit is further configured to write the data to the second physical unit union according to the write command, remap the first logical unit union address to the second physical unit union, associate the first physical unit union with the second area and associate the second physical unit union with the data area.

23. The memory controller as claimed in claim 21, wherein the memory management circuit is further configured to copy valid data in the first physical unit union to the second physical unit union.

24. The memory controller as claimed in claim 21, wherein when the plurality of logical unit union addresses is configured, the plurality of physical unit unions in the second area is non-mappable to the plurality of logical unit union addresses, and each of the plurality of physical unit unions in the data area is mapped to one of the plurality of logical unit union addresses.

25. The memory controller as claimed in claim 21, wherein the memory management circuit is further configured to create an invalid file in the file system, set the invalid file to be accessed by the second logical unit union address and set the invalid file as inaccessible.

26. The memory controller as claimed in claim 25, wherein the file system comprises a file allocation table area, a root directory area and a file area, wherein the file allocation table area has a plurality of cluster entry fields, the root directory area has a plurality of directory entry fields, and the file area has a plurality of clusters, wherein each of the plurality of cluster entry fields records a cluster entry, and each of the plurality of clusters corresponds to one of the plurality of cluster entry fields,
wherein the memory management circuit is configured to obtain a plurality of second cluster entry fields from the plurality of the cluster entry fields, wherein the second cluster entry fields are spare and the plurality of clusters corresponding to the second cluster entry fields belong to the second logical unit union address,
wherein the memory management circuit is configured to allocate the second cluster entry fields to the invalid file and to modify the cluster entries recorded in the second cluster entry fields according to the invalid file, and
wherein the memory management circuit is configured to generate a file description block corresponding to the invalid file, wherein the file description block corresponding to the invalid file records an initial cluster storing the invalid file.

27. The memory controller as claimed in claim 26, wherein the memory management circuit is configured to record the file description block corresponding to the invalid file in one of the plurality of directory entry field.

28. The memory controller as claimed in claim 26, wherein the memory management circuit is configured to create an invalid file directory and store the invalid file directory in the plurality of clusters in the file area,
wherein the memory management circuit is configured to create a file description block corresponding to the invalid file directory and record the file description block corresponding to the invalid file directory in one of the plurality of directory entry fields, and
wherein the memory management circuit is configured to record the file description block corresponding to the invalid file in the invalid file directory.

29. The memory controller as claimed in claim 26, the memory management circuit is configured to execute a card locking procedure on the rewritable non-volatile memory module when the second cluster entry fields do not exist in the plurality of cluster entry fields, wherein the card locking procedure is configured to forbid executing an writing operation on the rewritable non-volatile memory module.

30. The memory controller as claimed in claim 21, wherein the memory management circuit is further configured to determine whether a fourth physical unit union which is writable exists in the second area.
